(19) United States
(12) Patent Application Publication
(10) Pub. No.: US 2005/0193069 A1
(43) Pub. Date: Sep. 1, 2005

(54) Providing a portion of an electronic mail message based upon a transfer rate and a message size

(75) Inventors: Michael W. Brown, Georgetown, TX (US); Michael A. Paolini, Austin, TX (US); Newton J. Smith, Austin, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/787,998

(22) Filed: Feb. 26, 2004

(51) Int. Cl. G06F 15/16; G06F 15/173; G06F 17/30

(52) U.S. Cl. 709/206; 709/224

(57) ABSTRACT

A method and an apparatus for providing a portion of an electronic mail message based upon a transfer rate and a message size are presented. The method includes determining a value associated with a data transfer rate, determining a value associated with a size of an electronic mail message, and determining mail transfer criteria. The method also includes selecting a portion of the electronic mail message based upon the determined transfer rate value, the determined value associated with the size of the electronic mail message, and the determined mail transfer criteria. The method further includes providing the selected portion of the electronic mail message.

### BACKGROUND OF THE INVENTION

1. Field of the Invention

This invention relates generally to electronic mail messaging, and, more particularly, to providing a portion of an electronic mail message based upon a transfer rate and a message size.

2. Description of the Related Art

Electronic mail has become a central feature of modern life and users have come to expect to receive electronic mail messages at any time and in virtually any place. For example, during the course of one day of travel, a user may receive electronic mail messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

Thus, depending on the circumstances, electronic mail messages may be transmitted and/or received by a wide variety of devices at any given time. In addition to the aforementioned end-user devices, such as desktop computers, laptop computers, cell phones, personal digital assistants, and the like, electronic mail messages typically also pass through a variety of network servers, network switches, hubs, routers, transmission lines, wireless transmission media, modems, interface cards, and the like. The transfer rates of these devices and/or media can vary by many orders of magnitude. For example, a laptop computer's modem may be limited to a transfer rate of 56K bits per second, a cable modem may easily provide data at a transfer rate of 1-2 megabits per second, and a T-3 connection may provide data at a transfer rate as high as 40 megabits per second.

The complexity and size of electronic mail messages has increased roughly in proportion with the available transfer rate. Early electronic mail message systems relied upon comparatively slow modems and thus these electronic mail messages were typically limited to short ASCII text documents. Modern electronic mail messaging systems, on the other hand, may utilize high-speed connections to transmit documents containing complex formatting, audio, graphics, video, and the like. For example, a user may send and/or receive an electronic mail messages with a PowerPoint attachment including formatted text, images, and animations. For another example, a user with the appropriate licenses may send and/or receive a feature length movie as an electronic mail message. The size of these files may easily exceed several megabytes, and users may expect to transmit even larger files in the future.

Despite the advantages of using high-speed connections to transmit large information-rich electronic mail messages, the same messages can become problematic when they must be transmitted by a lower speed connection. For example, a user reading electronic mail messages on a laptop computer connected to the Internet via a 14.4K dial-up modem may have to wait an inordinate amount of time for a large electronic mail message to be downloaded through the modem. As another example, a user writing electronic messages on the laptop computer connected to the Internet via a 14.4 Kbps (K bits per second) dial-up modem may want to attach a large document to an electronic mail message, but may have to wait an unreasonable amount of time for the electronic mail message to be uploaded through the modem. In addition, bottlenecks, heavy traffic, device malfunctions, severed transmission lines, geomagnetic storms, and the like can dramatically, and often unpredictably, decrease the transfer rate of even the highest speed networks.

The present invention is directed to addressing, or at least reducing, the effects of, one or more of the problems set forth above.

### SUMMARY OF THE INVENTION

In one aspect of the instant invention, a method of providing a portion of an electronic mail message based upon a transfer rate and a message size is presented. The method includes determining a value associated with a data transfer rate, determining a value associated with a size of an electronic mail message, and determining a mail transfer criteria. The method also includes selecting a portion of the electronic mail message based upon the determined transfer rate value, the determined value associated with the size of the electronic mail message, and the determined mail transfer criteria. The method further includes providing the selected portion of the electronic mail message. An apparatus for implementing the method, and an article comprising one or more machine-readable storage media containing instructions that when executed enable a processor to perform the method, are also presented.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a system for practicing one or more embodiments of the present invention.

FIG. 2 shows one embodiment of an e-mail that may be stored by an e-mail management module, in accordance with one embodiment of the present invention.

FIG. 3 conceptually illustrates one alternative embodiment of a system that may implement one or more embodiments of the present invention.

FIG. 4 illustrates one embodiment of a method for providing a portion of an electronic mail message, in accordance with one embodiment of the present invention.

FIG. 5A shows one exemplary embodiment of a user profile, in accordance with on embodiment of the present invention.

FIG. 5B shows one exemplary embodiment of a dialog box, in accordance with one embodiment of the present invention.

FIG. 6 shows a stylized block diagram of a processor-based device, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e. a definition that is different from the ordinary and customary meaning as understood by those skilled in the art, is intended to be implied by consistent usage of the term or phrase herein. To the extent that a term or phrase is intended to have a special meaning, i.e. a meaning other than that understood by skilled artisans, such a special definition will be expressly set forth in the specification in a definitional manner that directly and unequivocally provides the special definition for the term or phrase.

As will be described in detail below, the present invention provides for intelligent use of the bandwidth available for transmitting electronic mail messages, which will be referred to hereinafter as e-mails, in accordance with common usage. For example, in one embodiment of the present invention, an e-mail server may autonomously decide whether an e-mail should be uploaded and/or downloaded based upon environmental factors such as a connection speed of a local system to a remote server. In another embodiment, a user may decide, manually or using an automated process based upon selected user preferences, what portions of an e-mail are sent and/or received. The user may also be provided with notifications of what choices are available and what actions have been taken.

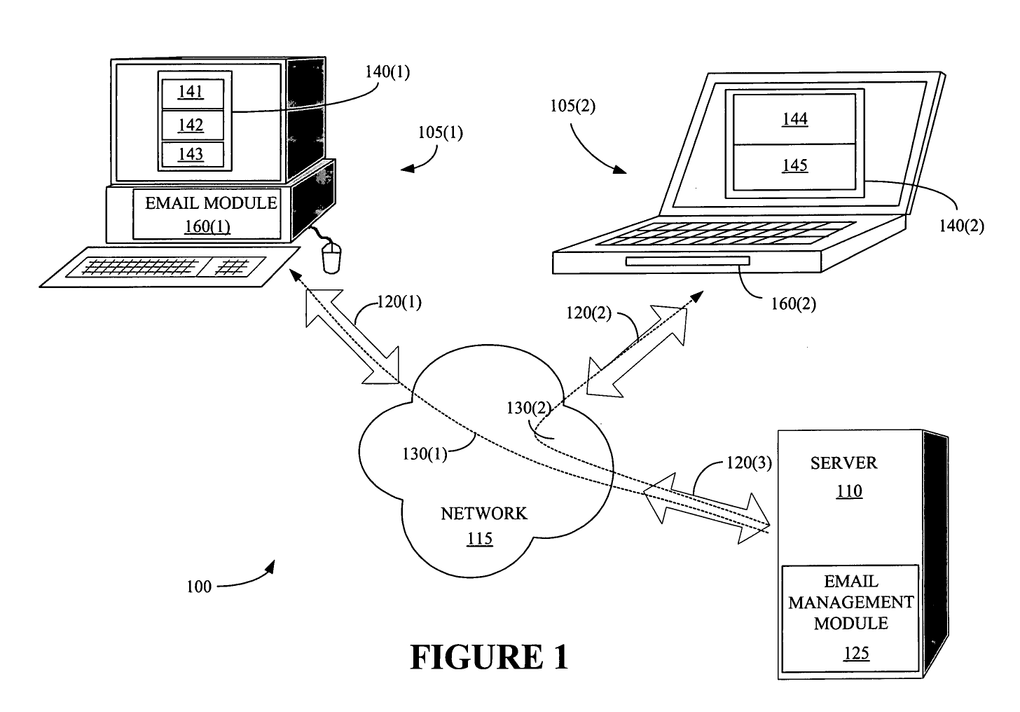

FIG. 1 illustrates a system 100 for practicing one or more embodiments of the present invention. In particular, FIG. 1 conceptually illustrates an embodiment that includes a plurality of processor-based devices 105(1-2) coupled to a server 110 by a network 115. In the illustrated embodiment, the processor-based device 105(1) is a desktop computer and the processor-based device 105(2) is a laptop computer, although in other embodiments, these processor-based devices 105(1-2) may be any desirable type of computer, personal digital assistant, cellular telephone, and the like.

The server 110, in one embodiment, may be one form of a processor-based device that can be accessed over the network 115. In accordance with one embodiment of the present invention, and as discussed below, the server 110, if desired, provides a less than the entire e-mail to a remote user. In one embodiment, the server 110 may be capable of performing tasks such as receiving, queuing, storing, and/or distributing e-mails to one or more users. Although not so limited, in one embodiment, one or more of the described embodiments of the present invention can be implemented within a conventional e-mail server, such as a Microsoft® Exchange Server. In the interest of clarity, the potential functionality of the server 110 not related to the present invention will not be described in further detail, as these tools and/or features are well known to persons of ordinary skill in the art.

In the embodiment illustrated in FIG. 1, the processor-based devices 105(1-2) and the server 110 are communicatively coupled to the network 115 over one or more communications links 120(1-3). In various alternative embodiments, the links 120(1-3) may be one or more of infrared links, wireless local area network (LAN) links, wired LAN connections such as Ethernet connections, cellular network links, circuit board traces, wires, cables, radiofrequency links, satellite links, and the like. Moreover, any desirable protocol may be used for communications between the processor-based devices 105(1-2) and the server 110 via the network 115. For example, a transmission control protocol/Internet protocol (TCP/IP), a user datagram protocol/Internet protocol (UDP/IP), a file transfer protocol or trivial file transfer protocol (FTP/TFTP), and the like may be used.

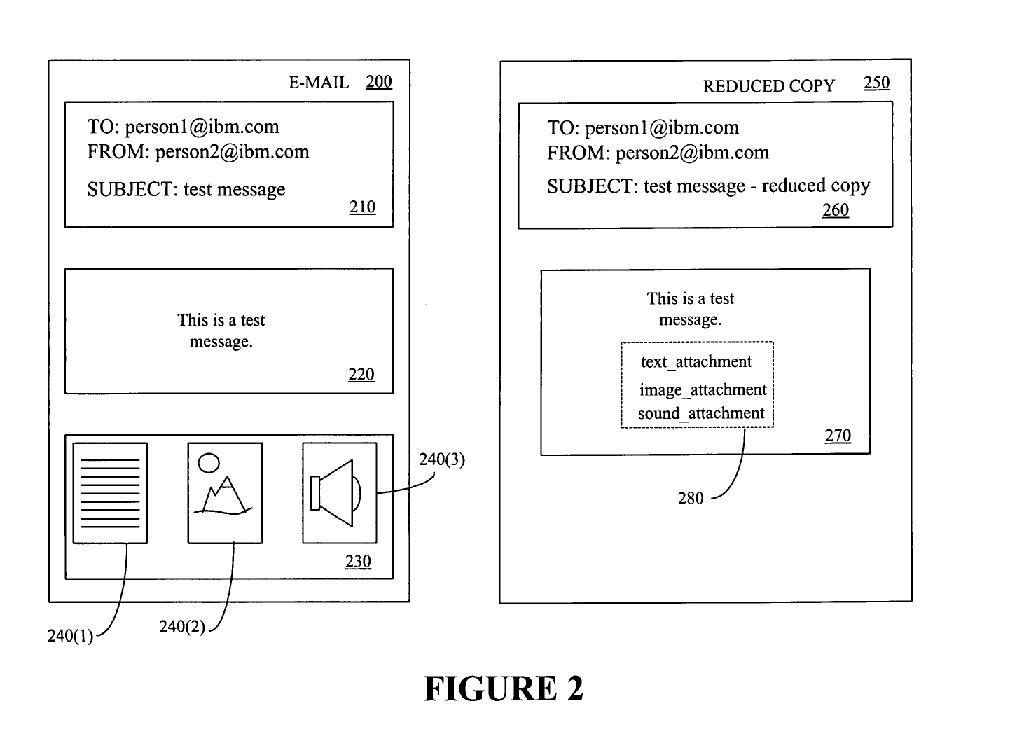

In the embodiment illustrated in FIG. 1, the server 110 includes an e-mail management module 125, which may process (e.g. receive, queue, store, and/or deliver) one or more one or more e-mails. One form of an e-mail 200 that may be processed by the e-mail management module 125 is shown in FIG. 2. In the embodiment illustrated in FIG. 2, the e-mail 200 includes a header 210, a body 220, and one or more attachments 230. The header 210 generally includes information indicative of the recipients of the e-mail (i.e. person1@ibm.com), the sender (i.e. person2@ibm.com), and the subject of the e-mail 200 (i.e. test message). The body 220 generally includes the message being conveyed. For example, in the e-mail 200, the body includes a text string, “This is a test message.”

The e-mail message 200 shown in FIG. 2 also includes attachments 240(1-3) that, in the illustrated embodiment, include a text document 240(1), a graphics file 240(2), and an audio file 240(3). However, persons of ordinary skill in the art will appreciate that any desirable number of files, as well as any desirable type and/or format of file, may be attached to the e-mail 200. Additionally, it should be appreciated that the e-mail 200 illustrated in FIG. 2 is exemplary in nature, and that in other embodiments it may include more, fewer, or different elements. For example, the e-mail 200 may only include a header 210 and a body 220. As another example, the e-mail 200 may also include routing information that may be used to direct the e-mail 200 to a desired destination.

Referring back to FIG. 1, the e-mail management module 125 on the server 110 provides the e-mail 200, or a selected portion, to one or more designated recipients, which, for illustrative purposes, are assumed to be the users of the processor-based systems 105(1-2). Thus, in this illustrative example, the e-mail management module 125 provides at least the selected portion of the e-mail 200 to the processor-based devices 105(1-2). However, persons skilled in the art will appreciate that, in alternative embodiments, any number of users of any desirable processor-based systems may be designated as the recipients and may receive portions of the e-mail 200 provided by the e-mail management module 125. The portion of the e-mail 200 transmitted to the user of each processor-based device 105(1) and 105(2) is hereinafter designated in FIG. 1 by reference numbers 140(1) and 140(2), respectively.

The e-mail management module 125 may provide the e-mail 200 via a variety of communication paths 130(1-2). In the illustrated embodiment, the e-mail management module 125 may transmit a selected portion of the e-mail 200 (designated by reference number 140(1)) to the processor-based device 105(1) along the communication path 130(1), which may include the link 120(3), the network 115, and the link 120(1). The e-mail management module 125 may also transmit a selected portion of the e-mail 200 (designated by reference number 140(2)) to the processor-based device 105(2) along the communication path 130(2), which may include the link 120(3), the network 115, and the link 120(2). Those skilled in the art will appreciate that communications paths 130(1-2) may include one or more intermediate gateways (not shown), routers (not shown), and the like.

As explained above, the data transfer rate along the communication paths 130(1-2) may vary by many orders of magnitude. For example, the communication path 130(1) may consist of a dedicated T-3 connection that may provide data at a transfer rate as high as 40 megabits per second. Accordingly, even if the attachments 240(1-3) attached to the e-mail 200 are large, e.g. 100 MB, the total time required to transfer the copy 140(1) may remain comparatively low, e.g. a few seconds in the case of the 100 MB attachments 240(1-3). In contrast, the communication path 130(2) may include a dial-up connection, such as the link 120(2), which may transfer data at a much lower rate. Thus, a user may have to wait several hours for the 100 MB attachments 240(1-3) to be transferred via the communication path 130(2). The long transfer time may inconvenience the user, particularly if the user does not wish to see the attachments 240(1-3), but does want to see one or more e-mails that may be transferred subsequently from the server 110.

In order to reduce the potential inconvenience to the user and increase the efficiency of the system 100, the e-mail management module 125, in one embodiment, may only transfer a portion of the e-mail 200 along one or more of the communication paths 130(1-2). For example, as will be discussed in detail below, the e-mail management module 125 may estimate a data transfer rate for the communication paths 130(1-2) and a size of the e-mail 200. In one embodiment, the estimated data transfer rate and the estimated size of the e-mail 200 may be used to estimate the time required to transfer the e-mail 200 along the communication paths 130(1-2).

The e-mail management module 125 may also determine a threshold time, such as a user's maximum preferred time to transfer the e-mail 200, and compare the determined threshold to the estimated e-mail transfer time. For example, the user may select a maximum preferred transfer time of approximately one minute. For another example, the user may select a maximum preferred transfer time of approximately zero minutes to force the e-mail management module to provide a reduced copy 140(2) of all e-mails 200. Alternatively, the threshold time may be a default time.

If the estimated e-mail transfer time is substantially less than the predetermined threshold time, the e-mail management module 125 may transmit substantially all of the e-mail 200. For example, the processor-based device 105(1) may receive the complete copy 140(1) of the e-mail message 200, including a header 141, a body 142, and one or more attachments 143. However, if the estimated e-mail transfer time is substantially more than the predetermined threshold time, and it is not desirable to transmit the entire e-mail 200, the e-mail management module 125 may transmit a portion of the e-mail 200. For example, the processor-based device 105(2) may receive the reduced copy 140(2) of the e-mail message 200, including a header 144 and a body 145.

FIG. 2 shows one embodiment of a reduced copy 250, which includes a header 260 and a body 270. The header 260 includes information indicative of the recipients of the e-mail (i.e. person1@ibm.com), the sender (i.e. person2@ibm.com), and the subject of the e-mail 200 (i.e. test message—reduced copy). The body 270 includes a text string, “This is a test message.” In addition, it one embodiment, the body 270 may also include an additional text string 280 that indicates the contents of the attachments 240(1-3). In the illustrated embodiment, the additional text string 280 includes the strings “text_attachment,” “image_attachment,” and “audio_attachment.” Although not shown in the FIG. 2, the additional text string 280 may include other information, such as estimated size of the attachments 240(1-3), the estimated transfer time for the entire e-mail 200 and/or for the attachments 240(1-3), and the like.

Referring back to FIG. 1, the e-mail management module 125 may, in alternative embodiments, “trickle download” the e-mail 200, i.e. successively download portions of the e-mail 200 in the background during one or more sessions, to the processor-based device 105(2). In one embodiment, the e-mail management module 125 may notify the user to indicate what choices are available, e.g. downloading the reduced copy 140(2) or trickle downloading the e-mail 200, and/or what actions have taken place.

Referring back to FIG. 1, the e-mail management module 125 may queue and/or store the e-mail 200. For example, if the reduced copy 140(2) has been transmitted to the processor-based device 105(2), the e-mail 200 may be queued and/or stored until a higher speed connection is available. As noted, a higher speed connection may be available for a variety of reasons, including the type of connectivity (e.g., T1 line as opposed to a telephone line), the type of processor-based device (e.g., a laptop computer as opposed to a PDA), and the like. In one embodiment, the e-mail management module 125 may periodically provide reminders, such as a pop-up dialog box, asking the user to connect to a high-speed connection and/or asking if the user would like to download the e-mail 200.

In one embodiment, the processor-based devices 105(1-2) may include e-mail modules 160(1-2), which may carry out a portion of the aforementioned processes or additional processes. For example, the e-mail modules 160(1-2) may allow a user to set up preferences as to how e-mails are to be handled. When the user is ready to process e-mails, the e-mail modules 160(1-2) may send a message to the server 110, such as a POP3 or IMAP server 110, which may cause various flags to be set based upon the user preferences. Examples of flags may include, “Queue send for high speed connection,” “Queue flagged target(s) receive for high speed connection,” “Don't download attachments greater than xKB,” “Prompt before downloading attachment(s),” and “Prompt before uploading attachment(s).” E-mails may then be processed in accordance with the user preferences indicated by the flags, as will be discussed in detail below. The modules 125, 160(1-2) illustrated in FIG. 1 are implemented in software, although in other implementations the modules 125, 160(1-2) may also be implemented in hardware or a combination of hardware and software.

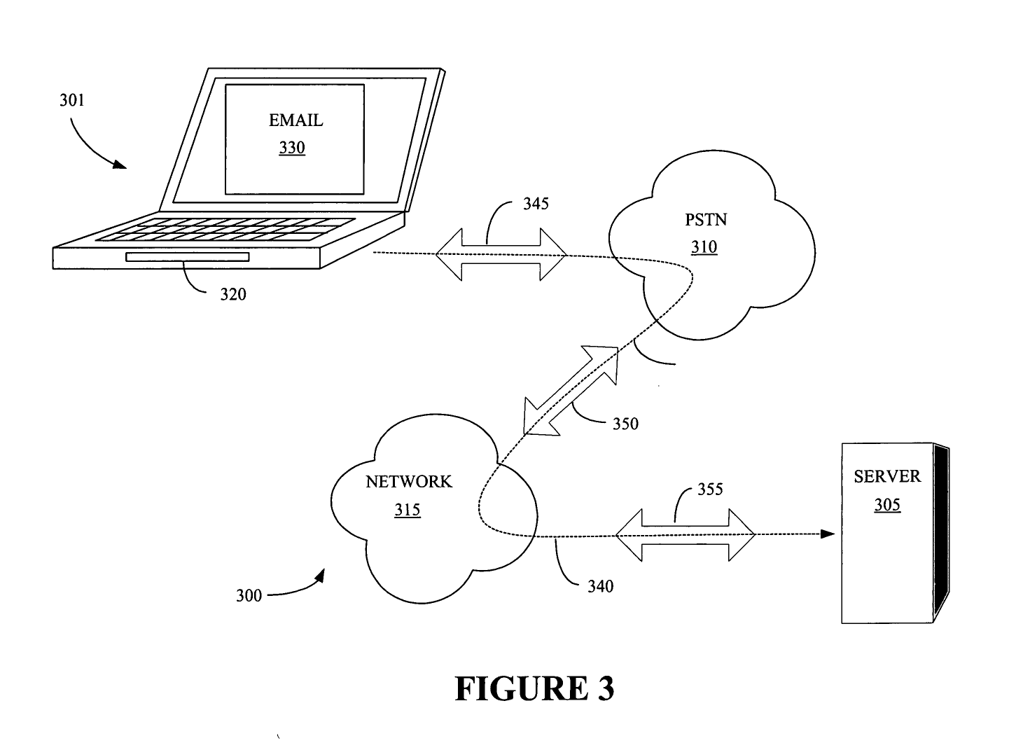

FIG. 3 conceptually illustrates a system 300 that may implement one or more alternative embodiments of the present invention. In FIG. 3, a processor-based device 301 is communicatively coupled to a server 305 by a public switched telephone network (PSTN) 310 and a network 315. Thus, the transmission of e-mails from the processor-based device 301 to the server 305 may be implemented in the alternative embodiment shown in FIG. 3. In the illustrated embodiment, the processor-based device 301 includes an e-mail management module 320 that may provide a copy of an e-mail 330 to the server 305. For example, in the illustrated embodiment, the e-mail management module 320 may transmit at least a portion of the e-mail 330 to the server 310 along the communication path 340, which may include the link 345, the public switched telephone network 310, the link 350, the network 315, and the link 355.

As discussed above, the data transfer rate along the communication path 340 may vary by many orders of magnitude. For example, if the processor-based device 301 is linked to the public switched telephone network (PSTN) 310 via a 14.4 Kbps modem (not shown), it may not be desirable to transmit a 100 MB attachment (not shown) to the server 305. Thus, the e-mail management module 320 may only transmit a portion of the e-mail 330 along the communication path 340. Alternatively, the e-mail 330 may be trickle uploaded to the server 305 along the communication path 340.

In one embodiment, after transmitting the portion of the e-mail 330 along the communication path 340, the e-mail management module 320 may queue and/or store the e-mail 330 until a faster connection becomes available. For example, a user may later connect the processor-based device 301 to the network 315 via a higher-speed connection, such as an Ethernet, and then the e-mail management module 320 may transmit the e-mail 330 using the higher speed connection. Alternatively, the user may later connect to the network 315 using a different processor-based device 301 (e.g., switch from a PDA to a laptop computer), where the processor-based device 301 employed by the user may, for example, support a higher-speed connection. In one embodiment, the e-mail management module 320 may periodically provide reminders, such as a pop-up dialog box, asking the user to connect to a high-speed connection and/or asking if the user would like to upload the e-mail 330.

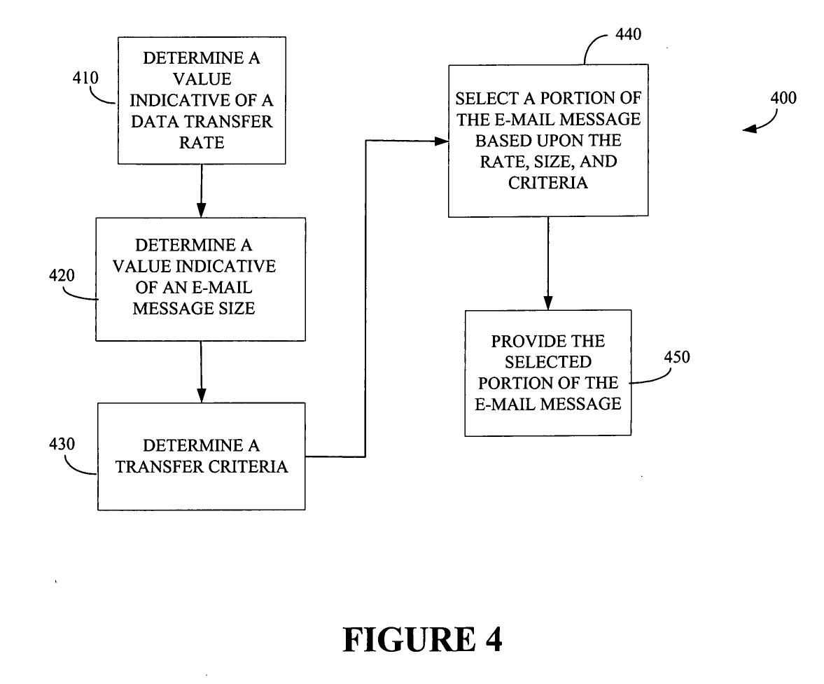

FIG. 4 illustrates one embodiment of the method of 400 for providing a portion of an e-mail based upon a data transfer rate, a size of the e-mail, and a threshold time. In the illustrated embodiment, a value indicative of, or associated with, a data transfer rate is determined (at 410). For example, an e-mail management module, such as the e-mail management modules 125, 320 and/or the e-mail modules 160(1-2), may determine (at 410) an average data transfer rate using one or more data packets received within a time period. Alternatively, the e-mail management module may determine (at 410) a data transfer rate using a device profile. For example, the e-mail management module may determine (at 410) that a 14.4 Kbps modem is being used to transmit data and, thus, the e-mail management module may determine (at 410) that the data transfer rate may not exceed approximately 14.4 Kbps. Persons of ordinary skill in the art should appreciate that the aforementioned techniques for determining (at 410) the data transfer rate are exemplary and not intended to limit the present invention.

A value indicative of, or associated with, a size of an e-mail is also determined (at 420). In one embodiment, the e-mail management module may determine (at 420) the size of the e-mail by determining (at 420) the number of bits in the e-mail. Alternatively, the size of the e-mail may be determined (at 420) using information that may be transmitted with the e-mail.

A mail transfer criteria is also determined (at 430). In the previously discussed embodiments of the present invention, the mail transfer criteria has been associated with a mail transfer threshold time, such as a user's preferred maximum transfer time or a default threshold time. In these embodiments, the mail transfer criteria is determined (at 430) by determining the threshold time using an indication of the user's preferred maximum transfer time, such as a user profile, or an indication of the default threshold time. However, the potential mail transfer criteria are not limited to the threshold time. In alternative embodiments, the mail transfer criteria may include various user preferences such as a maximum size of an attachment, a minimum average data transfer rate, a time of day, and the like.

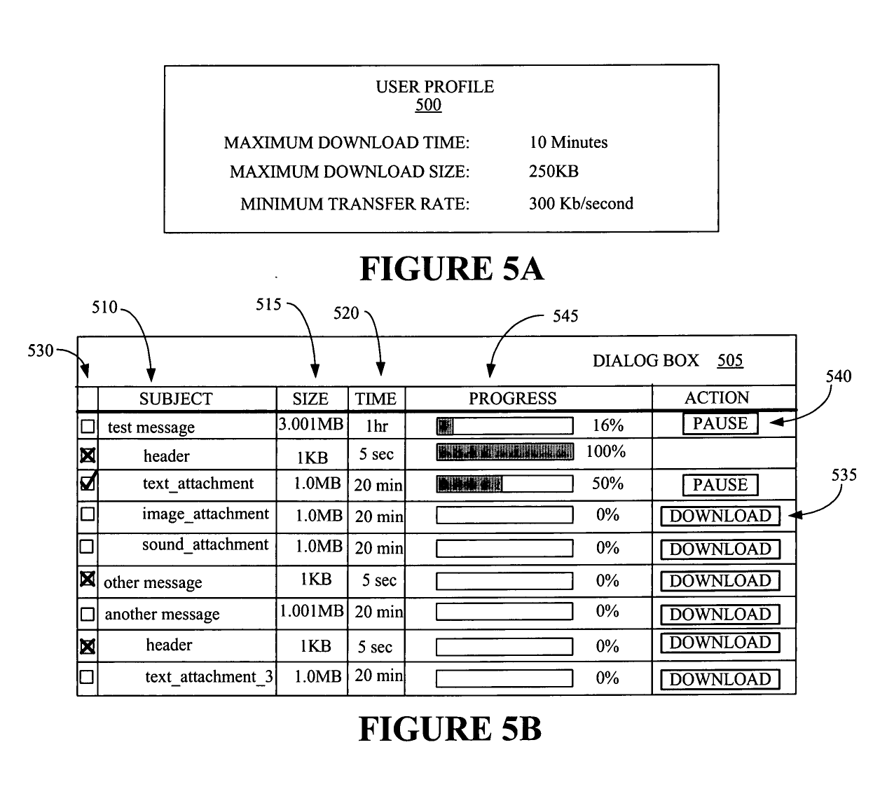

In one embodiment, illustrated in FIG. 5A, a user may provide a user profile 500 indicating the user preferences that may be used to determine (at 430) the mail transfer criteria. For example, the user may indicate, via the user profile 500, that e-mails that can be downloaded within a preselected time (e.g., in 10 minutes or less) should be downloaded. Alternatively, the user profile 500 may indicate that e-mails smaller than a preselected size (e.g., about 250 KB or less) should be downloaded and/or that e-mails that can be downloaded at an average rate of greater than a preselected threshold (e.g., about 300 Kbps) should be downloaded. In one embodiment, some or all of the information stored in the user profile 500 may be manually provided by the user when the user connects to access the stored e-mails, or, alternatively, the information, if pre-stored, may be made available to a device (e.g., the server 110) desiring access to the stored information. Depending on the implementation, the user profile 500 may be pre-stored at any desirable location, including the processor-based devices 105(1-2), 301, the servers 110, 305, and the like.

For illustrative purposes, it is assumed that the user profile 500 is stored in a convenient location, and, if desired, can be accessed by the appropriate device and/or module, including the e-mail modules 160(1-2), 320, the e-mail management module 125, and the like. In one embodiment, when the user is ready to process one or more of the received e-mails, a message indicative of the information included in the user profile 500 may be sent to a server, such as the servers 110, 305, which may set flags based upon the user preferences. For example, the flags may indicate that the server 110, 305 should queue e-mails that are to be sent and/or received via a high speed connection, should not download attachments larger that the Maximum Download Size indicated in the user profile 500, should prompt before uploading and/or downloading attachments, and the like.

In some embodiments, flags may also be set on the processor-based-devices 105(1-2), 301 and other devices (not shown) such as third-party proxy servers, e.g. mail servers, and the like. However, persons of ordinary skill in the art should appreciate that the other devices, such as proxy servers, may have additional rules for handling e-mails. For example, a mail server may operate according to a rule that limits the size and/or number of copies of an e-mail that may be sent. The device rules may, in some instances, override the preferences and/or flags that may be determined according to some embodiments of the present invention. For example, the mail server may decline to send copies of a 50 MB e-mail to 100 users, regardless of the preferences that may be indicated by the user profile 500 and/or the flags that may be set on the processor-based-devices 105(1-2), 301 and other devices.

A portion of the e-mail is then selected (at 440) based upon the determined data transfer rate, the determined size of the e-mail, and the mail transfer criteria. For example, the server and/or one or more clients may use the aforementioned flags to automatically select (at 440) the portion of the e-mail. In one embodiment, the determined data transfer rate and the determined size of the e-mail may be used to estimate the total transfer time for the e-mail. The estimated transfer time may then be compared to the threshold time and, if the estimated transfer time does not exceed the threshold time, substantially all of the e-mail may be selected (at 440). However, if the estimated transfer time substantially exceeds the threshold time, a portion of the e-mail may be selected (at 440). In one embodiment, the e-mail management module may also provide the user with an option to select (at 440) the portion of the e-mail.

In one embodiment, illustrated in FIG. 5B, a dialog box 505 may be displayed to the user. However, persons of ordinary skill in the art will appreciate that the present invention is not limited to the dialog box 505. In alternative embodiments, any desirable type of user interface, including a graphical user interface or display, may be displayed to the user in order to provide information to, and/or receive information from, the user. The dialog box 505 may display a list of the e-mails and information associated with the e-mails. For example, as shown in FIG. 5B, one entry (indicated by the phrase “test message” in subject field 510) has a size field 515 that indicates that the size of the e-mail is approximately 3.001 MB and a download time field 520 that indicates that the entire e-mail may take approximately one hour to download at the current connection speed. Various portions and/or attachments may also be displayed in the dialog box 505. For example, the size field 515 indicates that the size of the header is approximately 1 KB and the download time field 520 indicates that the header may take approximately 5 seconds to download at the current connection speed. For another example, the size field 515 indicates that the size of the text_attachment is approximately 1.0 MB and the download time field 520 indicates that the text_attachment may take approximately 20 minutes to download at the current connection speed.

The e-mails, portions, and/or attachments displayed in the dialog box 505 may be determined in a variety of ways. In one embodiment, a user may determine the e-mails, portions, and/or attachments displayed in the dialog box 505. For example, a user may create an e-mail including one or more tags that indicate which e-mail portions and/or attachments should be displayed in the dialog box 505. For another example, a user may highlight a portion of the e-mail by clicking-and-dragging over the desired portion of the e-mail using a controllable pointer element, e.g. a mouse, a joystick, and the like. The user may then indicate that the highlighted portion should be displayed in the dialog box 505 by, for example, selecting an option from a drop-down menu using the controllable pointer element. The e-mail management module may then determine displayable information associated with the e-mails including, but not limited to, the size and estimated download time of the e-mail portions and/or attachments. However, persons of ordinary skill in the art should appreciate that the present invention is not limited to embodiments wherein the user determines the portions and/or attachments displayed in the dialog box 505. In alternative embodiments, the e-mail management module may determine the portions and/or attachments displayed in the dialog box 505. For example, the e-mail management module may determine the portions and/or attachments displayed in the dialog box 505 using information such as the user profile, the device profile, the file size, the connection speed, the estimated download time, and the like.

In one embodiment, the e-mail management module may select (at 440) portions of the e-mails to be downloaded. For example, based upon the user profile 500, the e-mail management module may select (at 440) the “header” of the “test message,” the “other message,” and the “header” of the “another message,” as indicated by the X-marks in selection field 530. Alternatively, the user may select (at 440) portions of the e-mail to be downloaded. For example, the user may control a pointer element on the graphical user display with a pointer controller having position and selection status responsive to operation by the user, such as a mouse, a joystick, and the like, to select (at 440) the text_attachment. For example, the user may use a mouse to click the box in the selection field, thereby selecting (at 440) the text_attachment, as indicated by the check-mark in the selection field 530.

The selected portion of the e-mail is then provided (at 450) to, for example, a processor-based device and/or a server. In one embodiment, the e-mail management module 125 automatically provides (at 450) the selected portion of the e-mail. In one alternative embodiment, the e-mail management module 125 may provide the user with an option to instruct the e-mail management module 125 to provide (at 450) the selected portion of the e-mail. For example, the user may dynamically instruct the e-mail management module 125 to provide (at 450) portions of the e-mail using, e.g., a download button 535 that may be provided, as shown in FIG. 5B. In various embodiments, the user may click on the download button 535 to provide (at 450) a new download or resume a previously paused download. For example, the user may elect to instruct the e-mail management module 125 to provide (at 450) a portion of a large e-mail after smaller e-mails have been provided (at 450). In this embodiment, the portion of the e-mail is provided (450) in response to the user opting to provide (at 450) the portion. In one alternative embodiment, the download button 535 may be provided within the e-mail.

In one embodiment, a pause button 540 may be provided so that the user may select (e.g., by clicking using a mouse or other controller) the pause button 540 to stop a download that is in progress. In one alternative embodiment, the pause button 540 may be provided within the e-mail. A progress field 545, or similar user interface widget, may also be provided to indicate how much of the selected portions have been downloaded. For example, the progress field 545 indicates that the header of the test message has been downloaded and approximately 50% of the text_attachment has been downloaded, i.e. approximately 16% of the e-mail has been downloaded.

In one embodiment, the e-mail is queued and/or stored, e.g. on a client or on a server, after the selected portion of the e-mail is provided (at 450). The e-mail may remain queued until it becomes desirable to provide the complete e-mail. In one embodiment, a user may create the e-mail on a processor-based device and the selected portion of the e-mail may be provided (at 450) to a server and/or another processor-based device. The e-mail may remain queued and/or stored on the processor-based device until it becomes desirable to provide the complete e-mail to the server and/or other processor-based device. Alternatively, the e-mail may remain queued and/or stored on a server until it becomes desirable to provide the complete e-mail. As discussed above, one or more notifications may be provided to the user indicating that the e-mail is queued and/or stored.

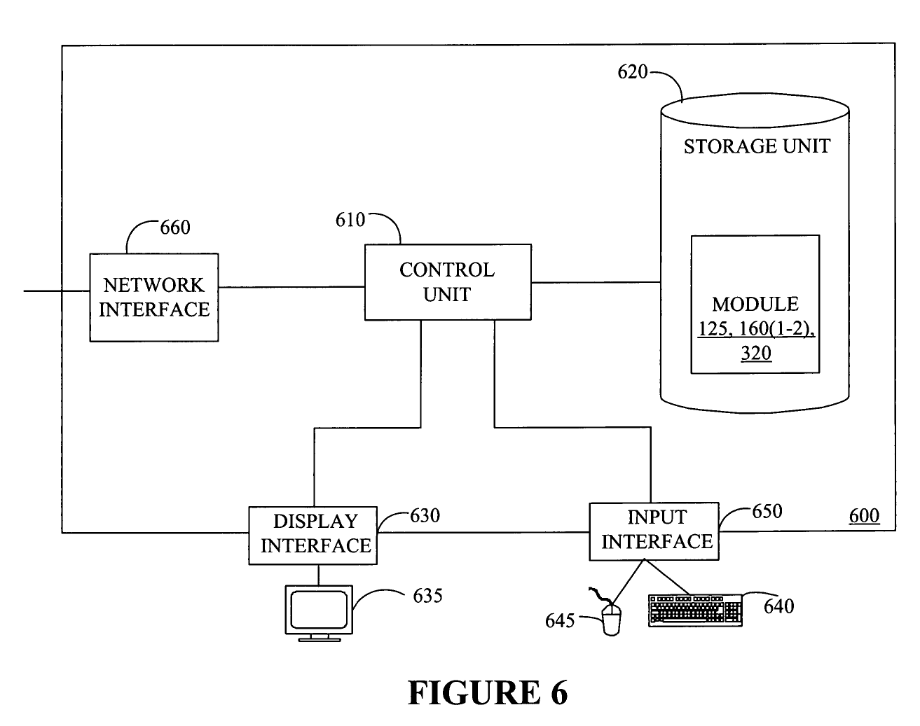

FIG. 6 shows a stylized block diagram of a processor-based device 600, in accordance with one embodiment of the present invention. In one embodiment, the processor-based device 600 may represent portions of the processor-based devices 105(1-2), 301 and/or the servers 110, 305. The device 600, depending on the particular implementation, is configured with the appropriate software configuration, including the e-mail management module 125 or the e-mail modules 160(1-2) of FIG. 1, or with the e-mail management module 320 in the system 300 of FIG. 3.

The device 600 comprises a control unit 610, which in one embodiment may be a processor that is communicatively coupled to a storage unit 620. The software installed in the storage unit 620 may depend on the features to be performed by the device 600. For example, if the device 600 represents one of the processor-based devices 105(1-2), 110, 301, 305 then the storage unit 620 may include the e-mail management modules 125, 320, as well as the e-mail modules 160(1-2). The e-mail management modules 125, 320 and the e-mail modules 160(1-2) may be executable by the control unit 610. Although not shown, it should be appreciated that in one embodiment an operating system, such as Windows®, Disk Operating System®, Unix®, OS/2®, Linux®, MAC OS®, or the like, may be stored on the storage unit 620 and be executable by the control unit 610. The storage unit 620 may also include device drivers for the various hardware components of the device 600.

In the illustrated embodiment, the device 600 includes a display interface 630. The device 600 may display information on a display device 635 via the display interface 630. In the illustrated embodiment, a user may input information using an input device, such as a keyboard 640 and/or a mouse 645, through an input interface 650. The control unit 610 is coupled to a network interface 660, which may be adapted to receive, for example, a local area network card. In an alternative embodiment, the network interface 660 may be a Universal Serial Bus interface or an interface for wireless communications. The device 600 communicates with other devices through the network interface 660. Although not shown, associated with the network interface 660 may be a network protocol stack, with one example being a UDP/IP or a TCP/IP stack. In one embodiment, both inbound and outbound packets may be passed through the network interface 660 and the network protocol stack.

It should be appreciated that the block diagram of the device 600 of FIG. 6 is exemplary in nature and that in alternative embodiments, additional, fewer, or different components may be employed without deviating from the spirit and scope of the instant invention. For example, if the device 600 is a computer, it may include additional components such as a system bus or an I/O bus. In other embodiments, the various elements of the device 600 may be interconnected using various buses and controllers. Similarly, depending on the implementation, the device 600 may be constructed with other desirable variations without deviating from the spirit and scope of the present invention.

The various system layers, routines, or modules may be executable on control units, such as the control unit 610. The control unit 610 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 610 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
determining a value associated with a data transfer rate;
determining a value associated with a size of an electronic mail message;
determining a mail transfer criteria;
selecting a portion of the electronic mail message based upon the determined transfer rate value, the determined value associated with the size of the electronic mail message, and the determined mail transfer criteria; and
providing the selected portion of the electronic mail message.

2. The method of claim 1, wherein determining the value associated with the data transfer rate comprises determining the value associated with the data transfer rate based upon at least one received data packet.

3. The method of claim 2, wherein determining the value associated with the data transfer rate based upon the received data packet comprises determining an average data transfer rate using data in the received data packet and a time period associated with the received data packet.

4. The method of claim 1, wherein determining the value associated with the data transfer rate comprises determining the value associated with the transfer rate based upon a device profile.

5. The method of claim 1, wherein determining the mail transfer criteria comprises determining the mail transfer criteria based upon at least one of a user input, a user profile, and a device profile.

6. The method of claim 1, wherein determining the mail transfer criteria comprises determining at least one of a threshold time, a maximum attachment size, a minimum average transfer rate, a time of day, a default threshold time and a user's preferred maximum transfer time.

7. The method of claim 6, wherein selecting the portion of the electronic mail message comprises estimating a transfer time using the determined value associated with the data transfer rate and the determined value associated with the size of the electronic mail message.

8. The method of claim 7, wherein selecting the portion of the electronic mail message comprises comparing the threshold time and the estimated transfer time.

9. The method of claim 1, wherein providing the selected portion of the electronic mail message comprises:
transmitting the selected portion of the electronic mail message; and
storing the electronic mail message.

10. The method of claim 9, wherein providing the selected portion of the electronic mail message comprises transmitting the selected portion from a server to a processor based device and storing the electronic mail message on the server.

11. The method of claim 9, wherein providing the selected portion of the electronic mail message comprises transmitting the selected portion from a processor-based device to a server and storing the electronic mail message on the processor based device.

12. The method of claim 1, further comprising providing a user at least one of an indication of the selected portion and an option to provide the selected portion.

13. The method of claim 12, wherein providing the selected portion comprises providing the selected portion in response to the user opting to provide the selected portion.

14. The method of claim 1, wherein providing the selected portion of the electronic mail message comprises at least one of trickle uploading and trickle downloading the electronic mail message.

15. The method of claim 1, further comprising providing the electronic mail message substantially after providing the selected portion of the electronic mail message.

16. An article comprising one or more machine-readable storage media containing instructions that when executed enable a processor to:
determine a value associated with a data transfer rate;
determine a value associated with a size of an electronic mail message;
determine a mail transfer criteria;
select a portion of the electronic mail message based upon the determined transfer rate value, the determined value associate with the size of the electronic mail message, and the determined mail transfer criteria; and
provide the selected portion of the electronic mail message.

17. The article of claim 16, wherein the one or more machine-readable storage media contain instructions that when executed enable the processor to determine an average data transfer rate using data in at least one received data packet and a time period associated with the received data packet.

18. The article of claim 16, wherein the one or more machine-readable storage media contain instructions that when executed enable the processor to determine at least one of a threshold time, a default threshold time, a user's preferred maximum transfer time, a maximum attachment size, a minimum average transfer rate, and a time of day based upon at least one of a user input, a user profile, and a device profile.

19. The article of claim 16, wherein the one or more machine-readable storage media contain instructions that when executed enable the processor to compare at least one of the threshold time, the default threshold time, and the user's preferred maximum transfer time with the estimated transfer time.

20. The article of claim 16, wherein the one or more machine-readable storage media contain instructions that when executed enable the processor to:
transmit the selected portion of the electronic mail message; and
store the electronic mail message.

21. The article of claim 16, wherein the one or more machine-readable storage media contain instructions that when executed enable the processor to provide the electronic mail message substantially after providing the selected portion of the electronic mail message.

22. An apparatus, comprising:
an interface; and
a control unit coupled to the interface and adapted to:
determine a value associated with a data transfer rate;
determine a value associated with a size of an electronic mail message;
determine a mail transfer criteria;
select a portion of the electronic mail message based upon the determined transfer rate value, the determined value associate with the size of the electronic mail message, and the determined mail transfer criteria; and
provide the selected portion of the electronic mail message.

23. The apparatus of claim 22, wherein the control unit is adapted to determine the value associated with the data transfer rate using data in the received data packet and a time period associated with the received data packet.

24. The apparatus of claim 22, wherein the control unit is adapted to:
receive user input indicating user preferences;
set at least one flag based upon the received user input; and
determine the mail transfer criteria based upon the at least one flag.

25. The apparatus of claim 22, wherein the control unit is adapted to determine a mail transfer criteria indicating at least one of a threshold time, a maximum attachment size, a minimum average transfer rate, and a time of day, and wherein the control unit is adapted to determine at least one of a default threshold time and a user's preferred maximum transfer time.

26. The apparatus of claim 25, wherein the control unit is adapted to estimate a transfer time using the determined value associated with the data transfer rate and the determined value associated with the size of the electronic mail message, and wherein the control unit is adapted to select the portion of the electronic mail message by comparing the threshold time and the estimated transfer time.

27. The apparatus of claim 22, wherein the control unit is adapted to provide the selected portion of the electronic mail message to at least one of a processor-based device and a server via the interface.

28. The apparatus of claim 22, further comprising a storage unit, and, wherein the control unit is adapted to:
transmit the selected portion of the electronic mail message via the interface; and
store the electronic mail message on the storage unit.

29. The apparatus of claim 28, wherein the control unit is adapted to provide a notification of an unselected portion of the electronic mail message, wherein the notification includes an action button to initiate transfer of at least the unselected portion of the stored electronic mail message.

30. A method for interfacing with a user of a computer system having a graphical user display, comprising:
displaying at least one text string indicative of at least one portion of at least one electronic mail message;
displaying at least one indication of an estimated time to download the portion of the electronic mail message;
displaying at least one selection field corresponding to the at least one portion of the at least one electronic mail message;
monitoring the position and selection status of a pointer controller to detect that one of the at least one selection fields has been selected by the user; and
altering the appearance of the selected one of the at least one selection fields in response to detecting that one of the at least one selection fields has been selected by the user.

31. The method of claim 30, further comprising displaying a progress field indicative of a transferred portion of the at least one portion of the at least one electronic mail message.

32. The method of claim 30, further comprising:
displaying at least one action field corresponding to the at least one portion of the at least one electronic mail message;
monitoring the position and selection status of the pointer controller to detect that one of the at least one action fields has been selected by the user.

33. The method of claim 32, further comprising initiating or pausing a transfer of the at least one portion of the at least one electronic mail message in response to detecting that one of the at least one action fields has been selected by the user.

34. The method of claim 30, further comprising controlling a pointer element on the graphical user display with a user pointer controller, the pointer controller having position and selection status responsive to operation by the user.

35. The method of claim 30, further comprising selecting the at least one portion of the at least one electronic mail message using input provided by the user.
